(19) United States
(12) Patent Application Publication
(10) Pub. No.: US 2008/0092928 A1
(43) Pub. Date: Apr. 24, 2008

(54) Method and Apparatus for Treating Biofilm in an Appliance

(75) Inventors: Nyik Siong Wong, St. Joseph, MI (US); Joel A. Luckman, Benton Harbor, MI (US); Anthony H. Hardaway, Stevensville, MI (US); Raveendran Vaidhyanathan, St. Joseph, MI (US)

Correspondence Address: MCGARRY BAIR PC, 32 Market Ave. SW, SUITE 500, GRAND RAPIDS, MI, 49503, US

(73) Assignee: WHIRLPOOL CORPORATION, Benton Harbor, MI (US)

(21) Appl. No.: 11/745,231

(22) Filed: May 7, 2007

Related U.S. Application Data
(63) Continuation-in-part of application No. 11/599,025, filed on Nov. 14, 2006.
Application No. 11/599,025 is a continuation-in-part of application No. 11/583,559, filed on Oct. 19, 2006.

(51) Int. Cl. B08B 3/00

(52) U.S. Cl. 134/30; 68/12.01

(57) ABSTRACT

A method of sanitizing a washing machine, including the removal of a bio film from the wash chamber of a clothes washer.

### CROSS-REFERENCE TO RELATED APPLICATIONS

This application is a Continuation-in-Part of U.S. patent application Ser. No. 11/599,025, filed Nov. 14, 2006, which is a Continuation-in-Part of U.S. patent application Ser. No. 11/583,559, filed Oct. 19, 2006, both of which are incorporated herein by reference in their entirety.

### BACKGROUND OF THE INVENTION

1. Field of the Invention

The invention relates to a method for treating biofilm in an appliance, such as a washing machine.

2. Description of the Related Art

Biofilm is composed of populations or communities of microorganisms, which can include bacteria, fungi, archaea, algae, protozoa, and the like. The microorganisms are encased in protective polymeric compounds called extracellular polysaccharide (EPS) excreted by the microorganisms themselves. The EPS is a slimy, glue-like substance that helps to anchor the microorganisms to a variety of surfaces. Biofilm can develop and grow on any surface exposed to the microorganisms and moisture. Once formed and adhered to a surface, the biofilm can be difficult to remove and potentially destructive to the surface. Common examples of biofilm include the plaque on teeth and slime on rocks in rivers, streams, and lakes.

Some appliances, such as washing machines, fabric refreshing/revitalizing appliances, and dishwashers, provide environments conducive to biofilm formation. For example, some washing machines may have deposition surfaces in humid spaces with little or no air flow. In response to energy and water conservation trends and legislation mandates for washing machines, manufacturers have shifted from traditional deep fill washing machines to High Efficiency (HE) washing machines, which, depending on their machines, some consumers use standard high sudsing detergents rather than the recommended low sudsing detergents in the HE washing machines, and the use of the former in the HE washing machines can lead to biofilm formation. Moderate to high sudsing detergents may create excessive volumes of suds and foam, which float and deposit soils and undissolved detergent ingredients onto the surfaces of the washing machine. The depositions tend to build up in areas of the washing machine that are not submerged and/or flushed with adequate volumes of water during standard use of the washing machine and provide a food supply for microorganisms that are airborne and introduced into the washing machine with the clothes and accompanying soils. In the past, the normal periodic use of bleach in the washing machine to assist in cleaning the clothes has inhibited the growth of biofilms, however, some consumers today avoid the use of bleach in their wash cycle whenever possible. As a result, biofilm can form and grow on the washing machine surfaces, and the biofilm can lead to malodors emanating from the appliance and exposure of the clothes load to the microorganisms during the wash process.

### SUMMARY OF THE INVENTION

The invention relates to a method for cleaning and sanitizing an appliance, including the removal of a biofilm from a cleaning chamber of the appliance. The chamber may be heated without liquid in the chamber and then rinsed to remove all or a portion of the biofilm.

### BRIEF DESCRIPTION OF THE DRAWINGS

In the drawings:

FIG. 1 is a schematic view of an exemplary fabric treatment appliance in the form of a washing machine according to one embodiment of the invention.

FIG. 1A is a schematic view of an exemplary controller for the fabric treatment appliance of FIG. 1.

FIG. 2 is a flow chart of a method of treating biofilm in an appliance according to one embodiment of the invention.

FIG. 3 is a flow chart of an exemplary embodiment of the method of FIG. 2 for use with the fabric treatment appliance of FIG. 1.

FIG. 4 is a flow chart of a method of treating biofilm in an appliance according to another embodiment of the invention.

FIG. 5 is a flow chart of an exemplary embodiment of the method of FIG. 4 for use with the fabric treatment appliance of FIG. 1.

FIG. 6 is a flow chart of an exemplary embodiment of the method of FIG. 4 for use with the fabric treatment appliance of FIG. 1.

### DESCRIPTION OF EMBODIMENTS OF THE INVENTION

The invention provides methods for treatment of the biofilm in appliances. The appliance may be any appliance with a moist or wet environment susceptible to biofilm formation and growth. Examples of such appliances may include, but are not limited to, fabric treatment appliances and dishwashers. The appliances may have a cleaning chamber that receives articles, such as clothing and utensils, to be cleaned. As used herein “cleaning” and “clean” refer to any processing of the articles that converts the articles from one state to another. For example, the cleaning can be washing, rinsing, refreshing, revitalizing, sanitizing, drying, treating with a composition, etc. The chamber may be defined by a structure, and the structure may provide a surface for formation and growth of biofilm.

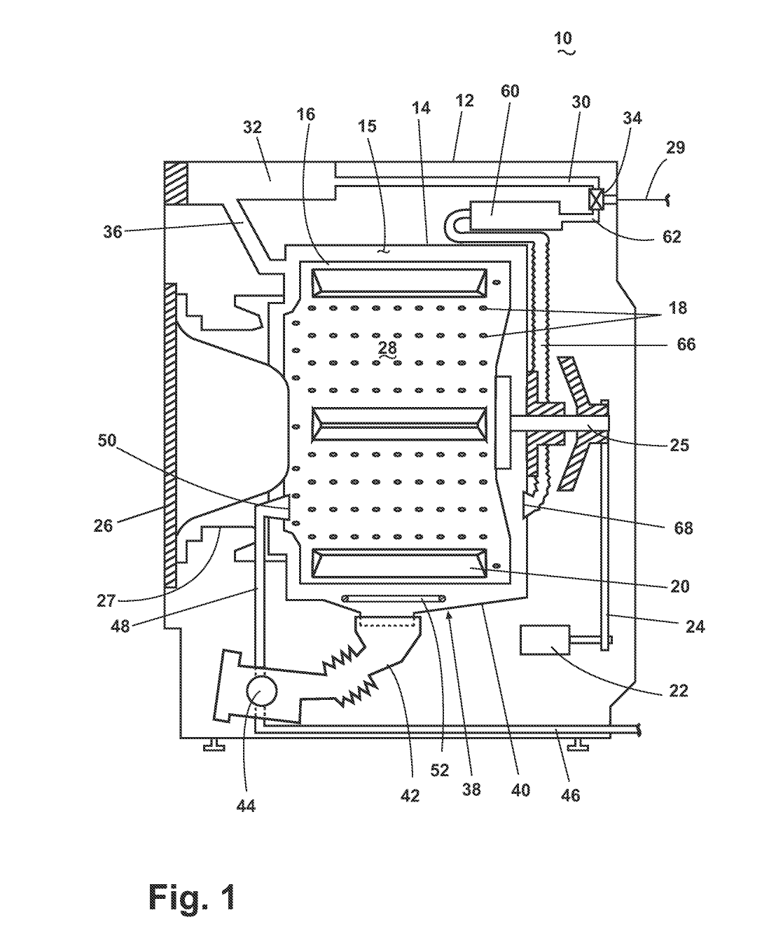

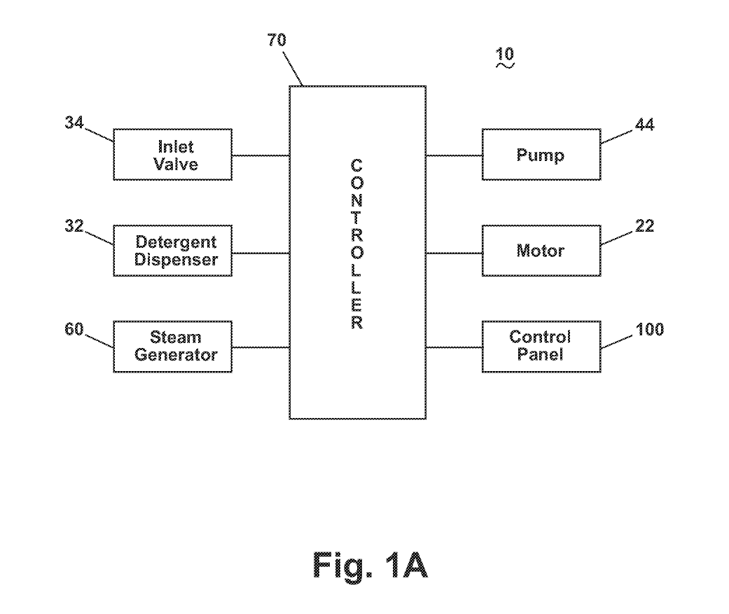

Referring now to the figures, FIG. 1 is a schematic view of an exemplary fabric treatment appliance in the form of a washing machine 10 according to one embodiment of the invention. The fabric treatment appliance may be any machine that treats fabrics, and examples of the fabric treatment appliance may include, but are not limited to, a washing machine, including top-loading, front-loading, vertical axis, and horizontal axis washing machines; a dryer, such as a tumble dryer or a stationary dryer, including top-loading dryers and front-loading dryers; a combination washing machine and dryer; a tumbling or stationary refreshing/revitalizing machine; an extractor; a non-aqueous washing apparatus; and a revitalizing machine. For illustrative purposes, the invention will be described with respect to a washing machine, with it being understood that the invention may be adapted for use with any type of appliance having biofilm.

The washing machine 10 of the illustrated embodiment may include a cabinet 12 that houses a stationary tub 14. A rotatable drum 16 mounted within the tub 14 may include a plurality of perforations 18, and liquid may flow between the tub 14 and the drum 16 through the perforations 18. The drum 16 may further include a plurality of baffles 20 disposed on an inner surface of the drum 16 to lift fabric items contained in the drum 16 while the drum 16 rotates, as is well known in the washing machine art. A motor 22 coupled to the drum 16 through a belt 24 and a drive shaft 25 may rotate the drum 16. Alternately, the motor 22 could be directly coupled with the drive shaft 25 as is known in the art. Both the tub 14 and the drum 16 may be selectively closed by a door 26. A bellows 27 couples an open face of the tub 14 with the cabinet 12, and the door 26 seals against the bellows 27 when the door 26 closes the tub 14. The tub 14, the door 26, and the bellows 27 form a structure that defines a cleaning chamber 28 for receiving fabric items to be cleaned. The structure may also include other elements in the chamber 28, such as the drum 16 and the drive shaft 25.

Washing machines are typically categorized as either a vertical axis washing machine or a horizontal axis washing machine. As used herein, the “vertical axis” washing machine refers to a washing machine having a rotatable drum, perforate or imperforate, that holds fabric items, and a fabric moving element, such as an agitator, impeller, nutator, and the like, that induces movement of the fabric items to impart mechanical energy to the fabric articles for cleaning action. In some vertical axis washing machines, the drum rotates about a vertical axis generally perpendicular to a surface that supports the washing machine. However, the rotational axis need not be vertical. The drum can rotate about an axis inclined relative to the vertical axis. As used herein, the “horizontal axis” washing machine refers to a washing machine having a rotatable drum, perforated or imperforate, that holds fabric items and washes the fabric items by the fabric items rubbing against one another as the drum rotates. In horizontal axis washing machines, the clothes are lifted by the rotating drum and then fall in response to gravity to form a tumbling action that imparts the mechanical energy to the fabric articles. In some horizontal axis washing machines, the drum rotates about a horizontal axis generally parallel to a surface that supports the washing machine. However, the rotational axis need not be horizontal. The drum can rotate about an axis inclined relative to the horizontal axis. Vertical axis and horizontal axis machines are best differentiated by the manner in which they impart mechanical energy to the fabric articles. In vertical axis machines, a clothes mover, such as an agitator, auger, impeller, to name a few, moves within a drum to impart mechanical energy directly to the clothes or indirectly through wash liquid in the drum. The clothes mover is typically moved in a reciprocating rotational movement. The illustrated exemplary washing machine of FIG. 1 is a horizontal axis washing machine.

The motor 22 may rotate the drum 16 at various speeds in opposite rotational directions. In particular, the motor 22 may rotate the drum 16 at tumbling speeds wherein the fabric items in the drum 16 rotate with the drum 16 from a lowest location of the drum 16 towards a highest location of the drum 16, but fall back to the lowest location of the drum 16 before reaching the highest location of the drum 16. The rotation of the fabric items with the drum 16 may be facilitated by the baffles 20. Typically, the radial force applied to the fabric items at the tumbling speeds may be less than about 1 G. Alternatively, the motor 22 may rotate the drum 16 at spin speeds wherein the fabric items rotate with the drum 16 without falling. In the washing machine art, the spin speeds may also be referred to as satellizing speeds or sticking speeds. Typically, the force applied to the fabric items at the spin speeds may be greater than or about equal to 1 G. As used herein, “tumbling” of the drum 16 refers to rotating the drum at a tumble speed, “spinning” the drum 16 refers to rotating the drum 16 at a spin speed, and “rotating” of the drum 16 refers to rotating the drum 16 at any speed.

The washing machine 10 of FIG. 1 may further include a liquid supply and recirculation system. Liquid, such as water, may be supplied to the washing machine 10 from a household water supply 29. A first supply conduit 30 may fluidly couple the water supply 29 to a detergent dispenser 32. An inlet valve 34 may control flow of the liquid from the water supply 29 and through the first supply conduit 30 to the detergent dispenser 32. The inlet valve 34 may be positioned in any suitable location between the water supply 29 and the detergent dispenser 32. A liquid conduit 36 may fluidly couple the detergent dispenser 32 with the tub 14. The liquid conduit 36 may couple with the tub 14 at any suitable location on the tub 14 and is shown as being coupled to a front-wall of the tub 14 in FIG. 1 for exemplary purposes. The liquid that flows from the detergent dispenser 32 through the liquid conduit 36 to the tub 14 typically enters a space between the tub 14 and the drum 16 and may flow by gravity to a sump 38 formed in part by a lower portion 40 of the tub 14. The sump 38 may also be formed by a sump conduit 42 that may fluidly couple the lower portion 40 of the tub 14 to a pump 44. The pump 44 may direct fluid to a drain conduit 46, which may drain the liquid from the washing machine 10, or to a recirculation conduit 48, which may terminate at a recirculation inlet 50. The recirculation inlet 50 may direct the liquid from the recirculation conduit 48 into the drum 16. The recirculation inlet 50 may introduce the liquid into the drum 16 in any suitable manner, such as by spraying, dripping, or providing a steady flow of the liquid.

The exemplary washing machine 10 may further include a steam generation system. The steam generation system may include a steam generator 60 that may receive liquid from the water supply 29 through a second supply conduit 62. The inlet valve 34 may control flow of the liquid from the water supply 29 and through the second supply conduit 62 to the steam generator 60. The inlet valve 34 may be positioned in any suitable location between the water supply 29 and the steam generator 60. A steam conduit 66 may fluidly couple the steam generator 60 to a steam inlet 68, which may introduce steam into the tub 14. The steam inlet 68 may couple with the tub 14 at any suitable location on the tub 14 and is shown as being coupled to a rear wall of the tub 14 in FIG. 1 for exemplary purposes. The steam that enters the tub 14 through the steam inlet 68 may subsequently enter the drum 16 through the perforations 18. Alternatively, the steam inlet 68 may be configured to introduce the steam directly into the drum 16. The steam inlet 68 may introduce the steam into the tub 14 in any suitable manner.

The washing machine 10 may further include an exhaust conduit (not shown) that may direct steam that leaves the tub 14 externally of the washing machine 10. The exhaust conduit may be configured to exhaust the steam directly to the exterior of the washing machine 10. Alternatively, the exhaust conduit may be configured to direct the steam through a condenser prior to leaving the washing machine 10. Examples of exhaust systems are disclosed in the following patent applications, which are incorporated herein by reference in their entirety: U.S. patent application Ser. No. 11/464,506, titled “Fabric Treating Appliance Utilizing Steam,” U.S. patent application Ser. No. 11/464,501, titled “A Steam Fabric Treatment Appliance with Exhaust,” U.S. patent application Ser. No. 11/464,521, titled “Steam Fabric Treatment Appliance with Anti-Siphoning,” and U.S. patent application Ser. No. 11/464,520, titled “Determining Fabric Temperature in a Fabric Treating Appliance,” all filed Aug. 15, 2006.

The steam generator 60 may be any type of device that converts the liquid to steam. For example, the steam generator 60 may be a tank-type steam generator that stores a volume of liquid and heats the volume of liquid to convert the liquid to steam. Alternatively, the steam generator 60 may be an in-line steam generator that converts the liquid to steam as the liquid flows through the steam generator 60. As another alternative, the steam generator 60 may have a heating element located in the sump 38 to heat liquid in the sump 38. The steam generator 60 may produce pressurized or non-pressurized steam.

Exemplary steam generators are disclosed in U.S. patent application Ser. No. 11/464,528, titled “Removal of Scale and Sludge in a Steam Generator of a Fabric Treatment Appliance,” U.S. patent application Ser. No. 11/450,836, titled “Prevention of Scale and Sludge in a Steam Generator of a Fabric Treatment Appliance,” and U.S. patent application Ser. No. 11/450,714, titled “Draining Liquid From a Steam Generator of a Fabric Treatment Appliance,” all filed Jun. 9, 2006, in addition to U.S. patent application Ser. No. 11/464,509, titled “Water Supply Control for a Steam Generator of a Fabric Treatment Appliance,” U.S. patent application Ser. No. 11/464,514, titled “Water Supply Control for a Steam Generator of a Fabric Treatment Appliance Using a Weight Sensor,” and U.S. patent application Ser. No. 11/464,513, titled “Water Supply Control for a Steam Generator of a Fabric Treatment Appliance Using a Temperature Sensor,” all filed Aug. 15, 2006, which are incorporated herein by reference in their entirety.

In addition to producing steam, the steam generator 60, whether an in-line steam generator, a tank-type steam generator, or any other type of steam generator, may heat water to a temperature below a steam transformation temperature, whereby the steam generator 60 produces hot water. The hot water may be delivered to the tub 14 and/or drum 16 from the steam generator 60. The hot water may be used alone or may optionally mix with cold water in the tub 14 and/or drum 16. Using the steam generator to produce hot water may be useful when the steam generator 60 couples only with a cold water source of the water supply 29.

The liquid supply and recirculation system and the steam generation system may differ from the configuration shown in FIG. 1, such as by inclusion of other valves, conduits, wash aid dispensers, and the like, to control the flow of liquid and steam through the washing machine 10 and for the introduction of more than one type of detergent/wash aid. For example, a valve may be located in the liquid conduit 36, in the recirculation conduit 48, and in the steam conduit 66. Furthermore, an additional conduit may be included to couple the water supply 29 directly to the tub 14 or the drum 16 so that the liquid provided to the tub 14 or the drum 16 does not have to pass through the detergent dispenser 32. Alternatively, the liquid may be provided to the tub 14 or the drum 16 through the steam generator 60 rather than through the detergent dispenser 32 or the additional conduit. As another example, the liquid conduit 36 may be configured to supply liquid directly into the drum 16, and the recirculation conduit 48 may be coupled to the liquid conduit 36 so that the recirculated liquid enters the tub 14 or the drum 16 at the same location where the liquid from the detergent dispenser 32 enters the tub 14 or the drum 16.

Other alternatives for the liquid supply and recirculation system are disclosed in U.S. patent application Ser. No. 11/450,636, titled “Method of Operating a Washing Machine Using Steam;” U.S. patent application Ser. No. 11/450,529, titled “Steam Washing Machine Operation Method Having Dual Speed Spin Pre-Wash;” and U.S. patent application Ser. No. 11/450,620, titled “Steam Washing Machine Operation Method Having Dry Spin Pre-Wash,” all filed Jun. 9, 2006, which are incorporated herein by reference in their entirety.

Referring to FIG. 1A, the washing machine 10 may further include a controller 70 coupled to various working components of the washing machine 10, such as the pump 44, the motor 22, the inlet valve 34, the detergent dispenser 32, and the steam generator 60, to control the operation of the washing machine 10. The controller may send/receive electrical signals and/or data to/from the working components to control their operation and to execute a desired operation of the washing machine 10.

The washing machine 10 provides several surfaces that may support the formation and growth of biofilm. The surfaces most susceptible to biofilm are those that are exposed to microorganisms and liquid. For example, the structure that defines the chamber 28, which may include the tub 14, the door 26, and the bellows 27, and the elements in the chamber 28, such as the drum 16 and the drive shaft 25, may be exposed to microorganisms and liquid and thereby function as surfaces to which the biofilm may adhere.

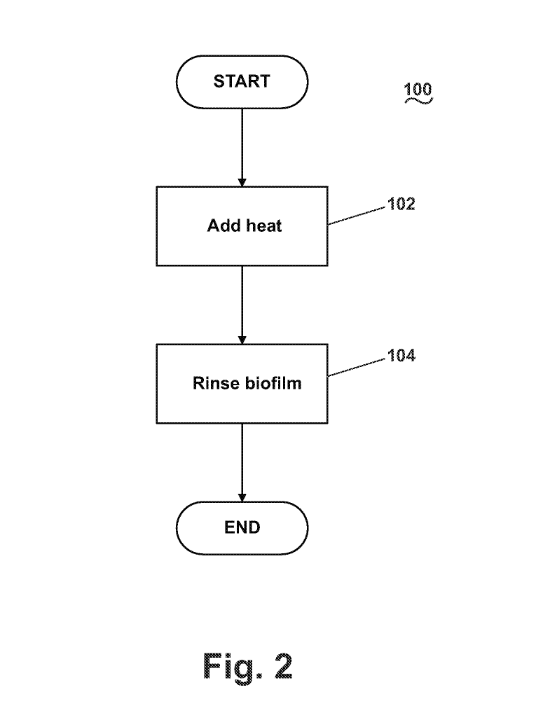

FIG. 2 is a flow chart of a method 100 of treating biofilm in an appliance according to one embodiment of the invention. The method 100 may include a heating step 102 and a rinsing step 104, and in the illustrated embodiment, the heating step 102 occurs prior to the rinsing step 104. In the heating step 102, a heat source heats the biofilm and the surface to which the biofilm adheres. Heating the biofilm and the surface may have synergistic effects on the biofilm. For example, the heat may loosen the biofilm from the surface by reducing the adhesion of the biofilm to the surface. Because the heat may loosen the biofilm from the surface, the biofilm may be more easily removed during the rinsing step 104, which will be described in more detail below. At the same time, the heat may kill the microorganisms in the biofilm, which may help prevent or retard growth of the biofilm and reduce production of the EPS. The heating of the surface may be effected by heating the appliance cleaning chamber. Additionally, the cleaning chamber may be heated with little or no liquid in the cleaning chamber to more effectively, efficiently, and expeditiously heat the chamber and thereby the surface. With liquid in the chamber, the heat must heat the liquid along with the chamber and the surface, which increases the time and amount of energy needed to heat the chamber and the surface. As used in this description, references to the “absence of liquid”, “no liquid” or “without liquid”, and the like, in the chamber does not exclude the presence of any liquid in the chamber. In the normal use of the washing machine, there is often residual liquid, but for all practical purposes there is no liquid in the tub or drum.

Heating the surface to a sufficient temperature may effectively sanitize the surface. As used herein, “sanitizing” refers to killing, removing, or otherwise rendering innocuous all or a portion of the microorganisms in the biofilm. The sanitizing process involves heating the surface to a sanitization temperature sufficiently high to sanitize the surface. In the sense of sanitizing to kill the microorganisms, the sanitizing process is a combination of temperature and time at temperature. Generally, the higher the temperature, the shorter the time at that temperature needed to kill the microorganisms. For the type of microrganisms commonly found in washing machines, there is a generally accepted lower temperature of 55° C. below which heat alone will not kill the microorganisms regardless of the length of time the microorganisms are exposed to these temperatures. However, if heat is used in combination with a chemistry, such as chlorine bleach or oxygenated bleach (a/k/a color safe bleach), lower temperatures can be used to sanitize. It is possible to sanitize solely with chemistry, but such a heavy use of chemistry may lead to the fabric breaking down more quickly.

Because of overall cycle time constraints, especially when heat alone is used to sanitize, the temperature is normally 60° C. or greater. A brief listing of sanitizing time and temperatures will aid in understanding. For 100° C., the temperature need only be maintained at about one minute to sanitize. For 70° C., the time is approximately 7 minutes. For 65° C., the time is approximately 20 minutes. For 55° C., the time is approximately one hour. As the temperature decreases and the corresponding time increases, there will come a point where the time to sanitize is greater than the time for the desired wash cycle, which will require that the wash cycle be extended, which is counter to the desire of most consumers, who generally prefer shorter wash cycles. The higher temperatures are normally balanced against the energy required to produce them. For example, most appliances in the United States have an approximately 115 V electrical supply, which inherently limits the wattage of the heater in the steam generator. In European countries, 220 V electrical supply is more common. In either case, there is a practical consideration on the rate and temperature at which heat or steam can be provided.

To complete the sanitizing within a time acceptable to the consumer, it has been determined that temperatures above 60° C. should be used. To avoid using more exotic or expensive heat systems or steam generators, a preferred range for the sanitization temperature may be from about 65° C. to about 75° C. Within this range, it has been determined that an exemplary suitable sanitization temperature is about 70° C. These ranges and specific temperatures have been found to address the overall cycle times and the heating requirements for current washers.

After the heating step 102, the biofilm may be rinsed from the cleaning chamber with liquid in the rinsing step 104. Rinsing the biofilm may remove the biofilm previously loosened and/or killed during the heating step 102. The rinsing may include introducing liquid at a flow rate sufficient to mechanically remove the biofilm from the surface. Furthermore, the liquid may submerge at least a portion of the surface to “soak” the biofilm and facilitate removal of the biofilm from the surface. Depending on the type of appliance, the liquid may be agitated within the chamber to aid in physical removal of the biofilm. Optionally, the liquid may include a pesticide, such as an antimicrobial, biocide, disinfectant, and sanitizer that may kill or otherwise treat the biofilm. Exemplary pesticides include bleaches, such as peroxide bleaches; other oxidizing chemicals; Microban chemicals; and silver, copper, and zinc ions. A pesticide may also be introduced during the heating step 102, but some chemicals, such as chlorine bleach, may be negatively affected by the heat (e.g., the heat may weaken the bleach and/or make the bleach corrosive). The rinsing step 104 may be repeated a predetermined number of times to ensure sufficient removal of the biofilm from the chamber.

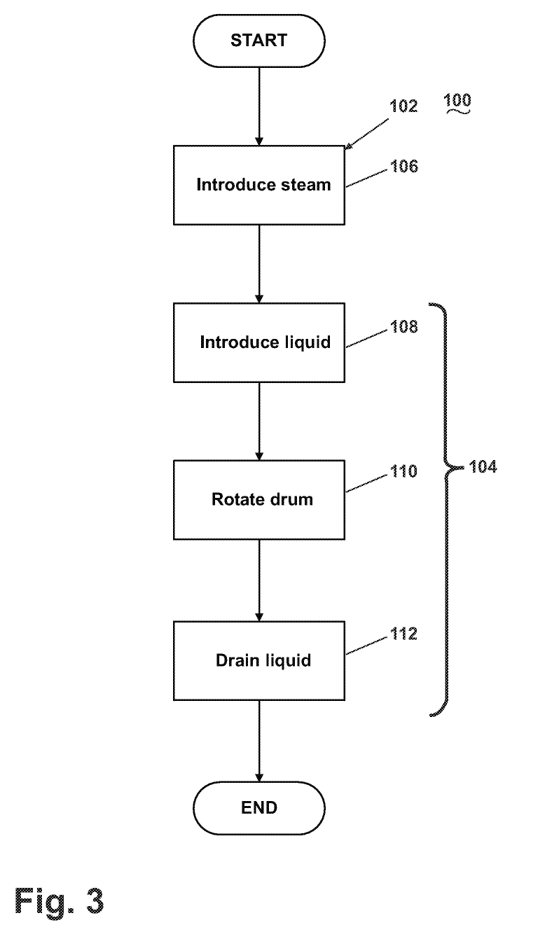

The method 100 may be adapted for use in any suitable appliance, and FIG. 3 is a flow chart of an exemplary embodiment of the method 100 of FIG. 2 for use with the exemplary washing machine 10 of FIG. 1. The heating step 102 may include a steam introduction step 106 whereby steam may be introduced into the chamber 28. The steam may be generated in the steam generator 60 from water supplied by the water supply 29 through the second supply conduit 62. The steam may be introduced into the chamber 28 through the steam conduit 66 and the steam inlet 68. The heating of the chamber 28 with the steam results in heating the structure that defines the chamber 28 and any elements in the chamber 28. For the illustrated embodiment, heating the chamber 28 may result in heating the tub 14, the drum 16, the drive shaft 25, the door 26, and the bellows 27 and any biofilm residing on these components. Because the components are each exposed to the steam, including the components in hard to reach places, such as the drive shaft 25 and a back side of the drum 16, the components may be uniformly heated to a desired temperature. Optionally, the steam may be introduced into the chamber 28 at high pressure to aid in physical removal of the biofilm from the surface. As another option, a pesticide or other chemical may be introduced into the chamber 28 with the steam, as described in more detail in U.S. patent application Ser. No. 11/583,559, titled “Washer with Bio Prevention Cycle,” filed Oct. 19, 2006, which is incorporated herein by reference in its entirety.

The steam may be introduced continuously or according to a duty cycle until the temperature of the chamber 28 reaches a predetermined temperature, such as the sanitization temperature. The temperature of the chamber 28 may be determined in any suitable manner. For example, the temperature of the chamber 28 may be determined with a temperature sensor positioned at or near the exhaust conduit for the tub 14, as described in more detail in the aforementioned and incorporated U.S. patent application Ser. No. 11/464,520. The heating of the chamber 28 may be executed with little or no liquid in the chamber 28 such that the heating of the chamber 28 and the structure occurs relatively fast with a relatively low thermal load, as compared to heating the chamber 28 and the structure with liquid in the chamber 28.

After the chamber 28 reaches the predetermined temperature, the steam may be introduced as needed to maintain the predetermined temperature for a predetermined time. The predetermined time may be an empirically determined time and may be a time corresponding to sufficient heating of the structure on which the biofilm resides and/or a time corresponding to sufficient loosening or killing of the biofilm. An exemplary predetermined time may be about 10 minutes.

Other heating devices may be used in place of the steam generator 60. A sump heater 52 could be used to heat the chamber 28. The sump heater 52 can heat the chamber 28 by direct radiation, heating water in the sump, or by generating steam from water in the sump. The sump heater 52 can be used in combination with the steam generator 60 to achieve a faster rate of heater and/or a higher temperature in the chamber.

It should be noted that while reference is made to heating the chamber 28, since the drum 16 resides in the chamber 15 of the tub 14, any heating of either chamber 15, 28, will necessarily result in the heating of the other chamber. Thus, to heat one of the chambers 15, 28, one could directly heat the chamber 15, 28 or indirectly heat it by heating the other chamber 15, 28. Any reference to heating a chamber in this application necessarily includes both a direct and indirect heating of the chamber.

Optionally, the heating step 102 may include drum rotation, such as during the steam introduction step 106. Rotation of the drum 16 during the introduction of steam aids in a more even distribution of steam throughout the chamber 28. As a result, the steam may be more easily distributed and may be evenly distributed in the chamber 28 regardless of the location of the steam inlet 68. Further, drum rotation may function to retain the steam in the chamber 28 rather than rising and leaking from the chamber 28 through any air passages, such as the aforementioned exhaust conduit, coupled to the chamber 28. The rotation of the drum tends to cause the steam to circulate with the chamber instead of naturally rising and escaping through any available openings. Also, some washers have a safety vent that is open whenever the drum is stopped, which provides an air path in case someone enters the washer and shuts the door, such as a child. When the drum rotates, the safety vent is closed, eliminating a conduit through which the steam can escape.

The drum 16 may rotate in any suitable manner; the drum 16 may rotate at tumbling speeds and/or spinning speeds, and the drum 16 may rotate in one direction or alternating directions. As an example, the drum 16 may rotate at tumbling speeds in alternating directions. An exemplary tumbling speed may be about 40 rpm. In a vertical axis washing machine, the fabric moving element may rotate instead of or in addition to rotation of the drum 16. The drum 16 may rotate for a predetermined time, which may be empirically determined. The drum 16 may rotate continuously or intermittently during the steam introduction step 106 and may rotate before the steam introduction step 106 initiates and/or after the steam introduction step 106 terminates.

Following the steam introduction step 106, the rinsing step 104 may begin with a liquid introduction step 108. The liquid introduction step 108 may include introducing water from the water supply 29 into the chamber 28 through the first supply conduit 30, the detergent dispenser 32, and/or the liquid conduit 36. The water may be introduced until the water reaches a predetermined level in the chamber 28. According to one embodiment, the predetermined level in the chamber 28 may be less than a level corresponding to submerging the drum 16 with the water. The predetermined level may be selected to ensure sufficient liquid agitation during a subsequent drum rotation step 110 yet avoid excessive drag on the drum 16 during the rotation of the drum 16 and leakage of the liquid through the door 26.

Optionally, a pesticide may be introduced into the chamber 28 with the water. For example, the detergent dispenser 32 may hold a supply of the pesticide, and the water may mix with the pesticide as the water flows through the detergent dispenser 32. Alternatively, the water may flow through another wash aid dispenser, such as a bleach dispenser holding a supply of bleach. The water may be any suitable temperature; heated water may be used to aid in sanitizing the structure. When the water and a pesticide negatively affected by heat are present in the chamber 28 at the same time, the water may be cold water to avoid destroying the efficacy of the pesticide and/or rendering the pesticide corrosive. Because the heating step 102 occurs prior to the liquid introduction step 108 and treats the biofilm, less pesticide may typically be used compared to a method without the heating step 102 (i.e., less pesticide may be needed to effect sufficient treatment of the biofilm).

The drum rotation step 110 may follow the liquid introduction step 108 and/or may be executed during the liquid introduction step 108. During the drum rotation step 110, the motor 22 rotates the drum 16 to induce agitation of the liquid in the chamber 28. The agitation of the liquid helps to physically remove the biofilm from the structure. The drum 16 may rotate in any suitable manner; the drum 16 may rotate at tumbling speeds and/or spinning speeds, and the drum 16 may rotate in one direction or alternating directions. As an example, the drum 16 may rotate at spinning speeds in alternating directions. An exemplary spinning speed may be about 150 rpm. In a vertical axis washing machine, the fabric moving element may rotate instead of or in addition to rotation of the drum 16. The drum 16 may rotate for a predetermined time, which may be empirically determined. Optionally, the liquid in the chamber 28 may be recirculated through the pump 44 and the recirculation conduit 48 during the liquid introduction step 108 and the drum rotation step 110.

After the drum rotation step 110, the liquid in the chamber 28 may be drained during a liquid draining step 112. The liquid may be drained from the sump 38 through the pump 44 and the drain conduit 46. Optionally, the liquid draining step 112 may include rotation, tumbling and/or spinning, of the drum 16 to aid in drying liquid residue in the chamber 28. The rotation of the drum 16 may occur during the draining of the liquid or can follow the draining of the liquid. Drying the liquid residue helps prevent formation and growth of biofilm following execution of the method 100.

The method 100 may end after the liquid draining step 112, or the heating step 102 and/or the rinsing step 104 may be repeated a desired number of times.

The method 100 may be executed as a stand-alone cycle or may incorporated into another cycle of the appliance. For example, the method 100 may be incorporated into a wash cycle or a sanitization cycle, such as the sanitization cycle disclosed in U.S. patent application Ser. No. 11/464,507, titled “Method of Sanitizing a Fabric Load with Steam in a Fabric Treatment Appliance,” filed Aug. 15, 2006. The method 100 may be automatically executed by the appliance, such as at preprogrammed time periods, or may be executed manually by a user.

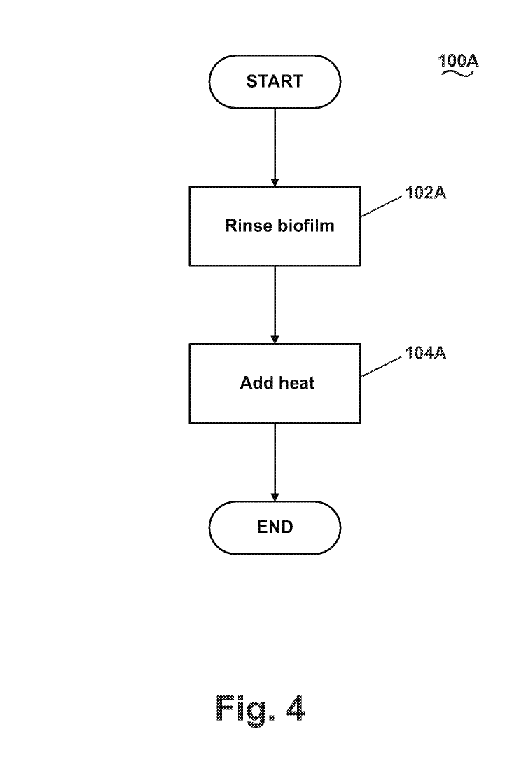

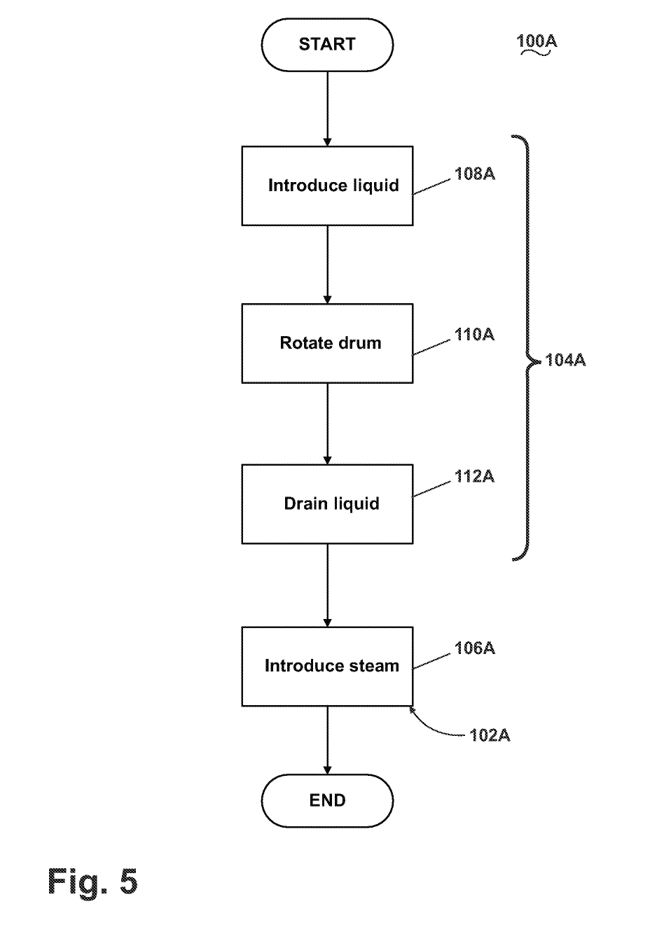

The method 100 may be executed in any suitable order. For example, the heating step 102 and the rinsing step 104 may be executed in reverse order, as illustrated in FIG. 4, which is a flow chart of a method 100A of treating biofilm in an appliance according to another embodiment of the invention. In FIG. 4, the steps of the method 100A are identical to those of the method 100 of FIG. 2 and are identified the with same reference numerals bearing the letter “A.” FIG. 5 is a flow chart of an exemplary embodiment of the method of FIG. 4 for use with the washing machine 10 of FIG. 1. In FIG. 5, the steps of the method 100A are identical to those of the method 100 of FIG. 3 and are identified the with same reference numerals bearing the letter “A.”

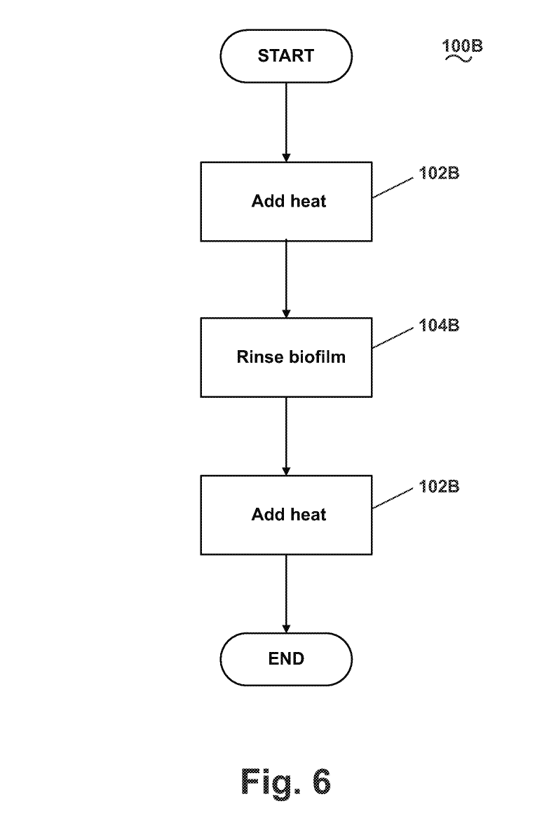

The method 100 may include any number of the heating step 102 and the rinsing step 104 in any desired order to achieve a desired treatment of biofilm. For example, the heating step 102 can both precede and follow the rinsing step 104, as illustrated in FIG. 6, which is a flow chart of a method 100B of treating biofilm in an appliance according to another embodiment of the invention. In FIG. 6, the heating step 102B and the rinsing step 104B of the method 100B are identical to those of the method 100 of FIG. 2. Performing a final heating step 102B after an initial heating step 102B and the rinsing step 104B may treat any biofilm not completely removed or otherwise treated during the initial heating step 102B and the rinsing step 104B. The final heating step 102B may be especially beneficial if a large amount of biofilm is present prior to execution of the method 100B or if the biofilm is sufficiently thick such that the initial heating step 102C and the rinsing step 104B cannot access the entire thickness of the biofilm. During the final heating step 102B, the heat may loosen the remaining biofilm from the surface by reducing the adhesion of the biofilm to the surface and may kill the microorganisms in the biofilm.

While the invention has been specifically described in connection with certain specific embodiments thereof, it is to be understood that this is by way of illustration and not of limitation, and the scope of the appended claims should be construed as broadly as the prior art will permit.

What is claimed is:

1. A method for removing a biofilm in an appliance comprising a structure defining a cleaning chamber, wherein the biofilm adheres to the structure, the method comprising:
heating the chamber to loosen the biofilm from the structure without liquid in the chamber; and
rinsing the loosened biofilm from the chamber with liquid.

2. The method of claim 1 wherein the heating of the chamber heats the structure to loosen the biofilm from the structure.

3. The method of claim 2 wherein the heating of the chamber comprises heating the chamber with steam.

4. The method of claim 3, further comprising introducing a pesticide into the chamber with the steam.

5. The method of claim 1 wherein the biofilm comprises one or more microorganisms, and wherein the heating of the chamber further comprises killing the microorganisms.

6. The method of claim 1 wherein the rinsing of the loosened biofilm comprises introducing the liquid into the chamber and agitating the liquid in the chamber.

7. The method of claim 1 wherein the appliance comprises a washing machine, and the structure comprises a rotatable element in the chamber, wherein the agitating of the liquid comprises rotating the rotatable element.

8. The method of claim 7 wherein the rotatable element comprises a drum.

9. The method of claim 8 wherein the structure comprises a tub in which the drum is rotatably mounted.

10. The method of claim 9 and further comprising rotating the drum during at least a portion of the heating of the chamber.

11. The method of claim 1 wherein the liquid comprises water and a pesticide.

12. The method of claim 1 wherein the loosening of the biofilm comprises reducing adhesion of the biofilm to the structure.

13. A method for removing biofilm from a clothes washer comprising a tub defining a chamber and a drum rotatably mounted within the chamber, the method comprising:
introducing steam into the chamber without water and clothing in the chamber to sanitize the tub and drum; and
rotating the drum during at least a portion of the steam introduction.

14. The method of claim 13 and further comprising rinsing the chamber.

15. The method of claim 14 wherein the rinsing of the chamber occurs after the introduction of steam.

16. The method of claim 15 and further comprising introducing steam into the chamber after the rinsing of the chamber.

17. The method of claim 15 wherein the rinsing of the chamber comprises introducing liquid into the chamber.

18. The method of claim 17 wherein the rinsing of the chamber further comprises rotating the drum while liquid is present in the chamber.

19. The method of claim 13 wherein the introducing of steam into the chamber raises the temperature in the chamber to at least 65° C.

20. The method of claim 13 wherein the introduction of steam into the chamber is sufficient to maintain the temperature in the chamber at 65° C. and higher for at least ten minutes.

21. A method for sanitizing a clothes washer comprising a tub defining a chamber and a drum rotatably mounted within chamber, the method comprising:
introducing steam into the chamber without water and clothing in the chamber;
rotating the drum during at least a portion of the steam introduction; and
rinsing the chamber with liquid.

22. The method of claim 21 and further comprising introducing steam into the chamber after the rinsing of the chamber.

23. The method of claim 21 wherein the rinsing of the chamber occurs after the introduction of steam.

24. The method of claim 21 wherein the introducing of steam into the chamber raises the temperature in the chamber to at least 65° C.

25. The method of claim 21 wherein the introduction of steam into the chamber is sufficient to maintain the temperature in the chamber at 65° C. and higher for at least ten minutes.

26. The method of claim 21 wherein the introduction of steam is sufficient to loosen a biofilm attached to one of the tub and drum.

27. A fabric treatment appliance for treating laundry, comprising:
a tub defining a washing chamber;
a drum rotatably mounted within the washing chamber and defining a laundry chamber;
a motor coupled to the drum to rotate the drum;
a liquid supply system fluidly coupled to at least one of the washing chamber and laundry chamber;
a steam generator fluidly coupled to at least one of the washing chamber and laundry chamber; and
a controller operably coupled to the motor, liquid supply system, and steam generator to control the operation of the motor, liquid supply system, and steam generator to implement a biofilm cycle by controlling the steam generator to introduce steam into the washing chamber to loosen the biofilm without the introduction of liquid into the washing chamber, and followed by the operation of the liquid supply system to rinse the loosened biofilm.

28. The fabric treatment appliance of claim 27 wherein the controller controls the motor to rotate the drum while the controller controls the steam generator to generate steam.

29. The fabric treatment appliance of claim 28 wherein the controller controls the liquid supply system to introduce liquid into the washing chamber and then controls the motor to rotate the drum with liquid in the washing chamber.

30. A fabric treatment appliance for treating laundry, comprising:
a tub defining a washing chamber;
a drum rotatably mounted within the washing chamber and defining a laundry chamber;
a motor coupled to the drum to rotate the drum;
a liquid supply system fluidly coupled to at least one of the washing chamber and laundry chamber;
a steam generator fluidly coupled to at least one of the washing chamber and laundry chamber; and
a controller operably coupled to the motor, liquid supply system, and steam generator to control the operation of the motor, liquid supply system, and steam generator to implement a biofilm cycle by controlling the operation of the steam generator to introduce steam into the washing chamber without the introduction of liquid into the washing chamber, and controlling the motor to rotate the drum during at least a portion of the operation of the steam generator.

31. The fabric treatment appliance of claim 30 wherein the controller controls the motor to rotate the drum at a spin speed.

32. The fabric treatment appliance of claim 31 wherein the controller controls the liquid supply system to rinse the washing chamber.

33. The fabric treatment appliance of claim 32 wherein the controller controls the liquid supply system to introduce liquid into the washing chamber and then controls the motor to rotate the drum with liquid in the washing chamber.
